(19) United States
(12) Patent Application Publication
(10) Pub. No.: US 2024/0389571 A1
(43) Pub. Date: Nov. 28, 2024

(54) SPRAY BOOM COMPRISING AT LEAST ONE SECONDARY DUCT SECTION

(71) Applicant: EXEL INDUSTRIES, EPERNAY (FR)

(72) Inventor: Sylvain PITAUD, CHANEINS (FR)

(73) Assignee: EXEL INDUSTRIES, EPERNAY (FR)

(21) Appl. No.: 18/670,179

(22) Filed: May 21, 2024

(30) Foreign Application Priority Data
May 24, 2023 (FR) 2305115

(51) Int. Cl. A01M 7/00

(52) U.S. Cl. CPC A01M 7/006; A01M 7/0071; A01M 7/0089

(57) ABSTRACT

The invention relates to a spray boom comprising a nozzle holder connected to a duct, comprising a first nozzle, a section, a group of nozzles, a flow regulating means arranged between the nozzle and the section and comprising at least one inlet and two outlets controllable between an open and closed position, said flow regulating means allowing supply of the nozzle and/or the group of nozzles with liquid, and in the closed position preventing their supply with liquid, in the open position of the first outlet or the second outlet, said flow regulating means allows supply of the nozzle and the section respectively, and in the closed position prevents supply of the first nozzle and the section respectively.

### TECHNICAL FIELD

The present invention relates to the field of agricultural spray systems. More precisely, the invention relates to a spray boom, comprising a primary duct and at least one nozzle holder connected to the primary duct as well as a secondary duct section.

### BACKGROUND

An agricultural spray boom generally comprises nozzle holders evenly distributed over the entire length of the spray boom, to spray plant protection product, in liquid form or liquid fertilizer for example, onto rows of plants. In particular, the well-known spray boom is designed to spray liquid onto the field, regardless of the type of crop planting, i.e. the width of the crop rows.

The boom comprises a plurality of nozzles spaced apart from each other, said spacing being fixed and the nozzles allowing a double or triple coverage of the surface area sprayed with the liquid. The well-known boom allows spraying the entire field, rather than in-line spraying. Such spraying can, depending on the user's need, spray more fluid than necessary, resulting in economic loss and soil pollution.

Crop row spray systems combined with a hoeing machine are also known. These spray systems allow more localized soil spraying. However, hoeing is done more in full sunlight, so that weeded grass is dehydrated, while spraying is done more in the early morning, when the sun is not yet present, so their combination is not compatible. In addition, the working speed of hoeing is close to 5 km/h, when the working speed of spraying is rather performed at around 15 km/h. Thus, crop row spray systems combined with a hoeing machine only spray at very low speed, i.e. typically 5 km/h. Spraying is therefore not carried out in good conditions for the user.

The invention aims to solve the aforementioned drawbacks of the state of the art, in particular by providing a spray boom comprising at least one nozzle holder for adapting to the product to be sprayed and to the desired spraying type, i.e. the entire field or localized spraying, while maintaining a spray working speed.

### SUMMARY

More specifically, one object of the invention is a spray boom for an agricultural sprayer. Said spray boom comprises a primary duct and at least one nozzle holder connected to said primary duct and comprises:
a body housing a liquid intake duct configured to be supplied with liquid by said primary duct and housing at least one flow regulating means;
at least one first spray nozzle;
at least one secondary duct section extending in parallel to the primary duct;
at least one group of spray nozzles distributed over the secondary duct section.

Said at least one flow regulating means is arranged at the interface between the intake duct, the first spray nozzle and the secondary duct section and comprises a liquid inlet and at least a first controllable outlet and a second controllable outlet disposed downstream of said primary duct, the inlet and each outlet being controllable between an open position and a closed position. The first spray nozzle is connected to one of the outlets of the flow regulating means and the secondary duct section is connected to the other of the outlets of the flow regulating means. In the open position of the liquid inlet, said flow regulating means is configured to enable supply of the first nozzle and/or the group of nozzles with liquid and, in the closed position of said liquid inlet, said flow regulating means is configured to prevent supply of the first nozzle and/or the group of nozzles with liquid. In the open position of the outlet connected to the first liquid nozzle, said flow regulating means is configured to enable supply of the first nozzle and, in the closed position of said liquid outlet, said flow regulating means is configured to prevent supply of the first nozzle. In the open position of the other liquid outlet, said flow regulating means is configured to enable supply of the secondary duct section and, in the closed position of said other liquid outlet, said flow regulating means is configured to prevent supply of the secondary duct section. Said spray boom is configured to spray liquid through said first spray nozzle and/or through at least one nozzle of said group of spray nozzles.

The flow regulating means can thus allow the liquid to be conveyed to the first outlet and thus to the first nozzle and to the second outlet and thus to the group of nozzles. The spray boom thus has at least one spraying level with the first spray nozzle and a second spraying level with the group of spray nozzles distributed over the secondary duct section. The first level can for example be adapted to a first spraying type such as spraying the entire field, and the second level to a second spraying type such as localized spraying. This allows the user to apply two different spraying types on a single boom. In addition, the nozzles of the group of nozzles can be adaptably distributed over the secondary duct section, and thus enable spraying adapted to the user's need and/or depending on the liquid to be sprayed.

Advantageously, the flow regulating means comprises two controllable valves, a first controllable valve being arranged at the interface between the intake duct and the secondary duct section, and a second controllable valve being arranged at the interface between the intake duct and the first spray nozzle, the first outlet of the flow regulating means corresponding to the outlet of the first valve and the second outlet of the flow regulating means corresponding to the outlet of the second valve.

Advantageously, the group of spray nozzles comprises at least two spray nozzles connected to each other through the secondary duct section, said secondary duct section being configured to convey liquid from the flow regulating means to each nozzle of said group of spray nozzles.

The nozzles in the group of spray nozzles allow spraying of the fluid conveyed at intervals determined by their spacing. Their spacing therefore varies depending on and adapts to the user's needs. For example, the user may determine that the space between their nozzles of the group of nozzles corresponds to the spacing between their rows, so as to make on-the-row or inter-row spraying, especially for weeding, with the group of nozzles.

Advantageously, a plurality of controllable valves are arranged in said secondary duct section, each valve of said plurality of valves being associated with one of the nozzles of the group of nozzles and each valve being movable between a closing position in which it is configured to prevent conveying of said liquid from the flow regulating member to the nozzle with which it is associated and an opening position in which it is configured to allow conveying of said liquid from the flow regulating member to the nozzle with which it is associated.

The valves allow the nozzles of the group of nozzles to be individually controlled. In particular, the user can determine the position of each valve, between its closing position and its opening position, in order to adapt the spray boom even better to their needs.

Advantageously, the spray nozzles of the group of spray nozzles are equidistant from each other.

Such an arrangement may, in particular, allow on-the-row or inter-row spraying.

Advantageously, the spray nozzles of the group of spray nozzles are spaced apart by 5 to 25 cm.

Advantageously, the first spray nozzle and/or at least one spray nozzle of the group of spray nozzles is tilted relative to the primary duct.

The tilt of the nozzles allows the spray spectrum of the nozzles to be adapted. In particular, this makes it possible to tighten the spray spectra of the nozzles so as to limit the sprayed field width, while keeping the same nozzle height.

Advantageously, said boom comprises a plurality of nozzle holders, each nozzle holder being connected to said primary duct.

The plurality of nozzle holders allows for even greater boom modularity, as each group of nozzles can have a different arrangement, specific to the user's need.

Advantageously, the nozzle holders of the plurality of nozzle holders are equidistant from each other.

Advantageously, the nozzle holders of the plurality of nozzle holders are spaced apart by 25 cm, or 33 cm or 50 cm.

### BRIEF DESCRIPTION OF THE DRAWINGS

The invention will be better understood upon reading the following description, given

solely as an example, and by referring to the accompanying figures, given as non-limiting examples, wherein identical references are given to similar objects and in which:

FIG. 1 is a perspective view, from the rear left of a nozzle holder connected to a boom according to the invention, said nozzle holder comprising a first nozzle, two secondary duct sections connecting the three nozzles of the group of nozzles;

FIG. 2 is a front view of the nozzle holder connected to the boom of FIG. 1;

FIG. 3 is a view similar to FIG. 1 but seen from the top and left;

FIG. 4 is a view similar to FIG. 1 but seen from the left;

FIG. 5 is a rear top view of the nozzle holder connected to the boom of FIG. 1;

FIG. 6 is a view similar to FIG. 5 but with a nozzle holder whose group of nozzles

comprises five nozzles, rather than three; and

FIG. 7 is a view similar to FIG. 5 but with a nozzle holder whose group of nozzles comprises two nozzles, rather than three and thus a single secondary duct section.

It should be noted that the figures set out the invention in detail in order to enable the

implementation of the invention; although non limiting, said figures are especially used to better define the invention where applicable.

### DETAILED DESCRIPTION

The invention relates to a spray boom 1. The spray boom 1 is in particular configured to be carried or towed by a vehicle, in particular an agricultural machine, herein an agricultural sprayer.

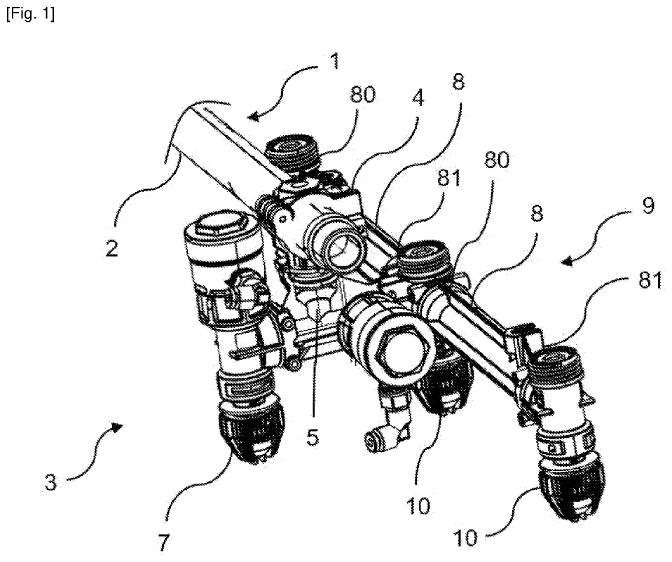

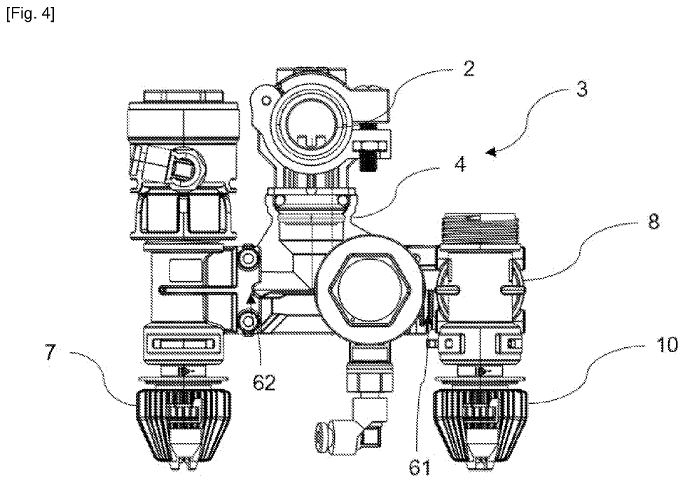

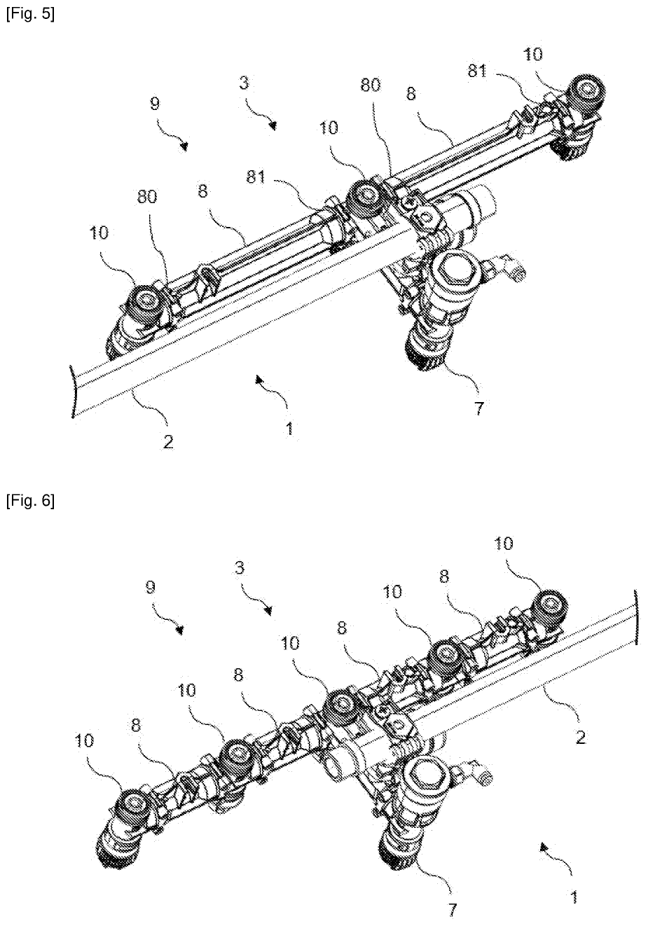

As is represented in FIGS. 1 to 7, the spray boom 1 comprises a primary duct 2 and at least one nozzle holder 3.

FIG. 1 shows a portion of the primary duct 2 to which the nozzle holder 3 is connected.

In particular, the nozzle holder 3 comprises a body 4. The function of the body 4 is to house the different components of the nozzle holder 3 and to connect the nozzle holder 3 to the primary duct 2.

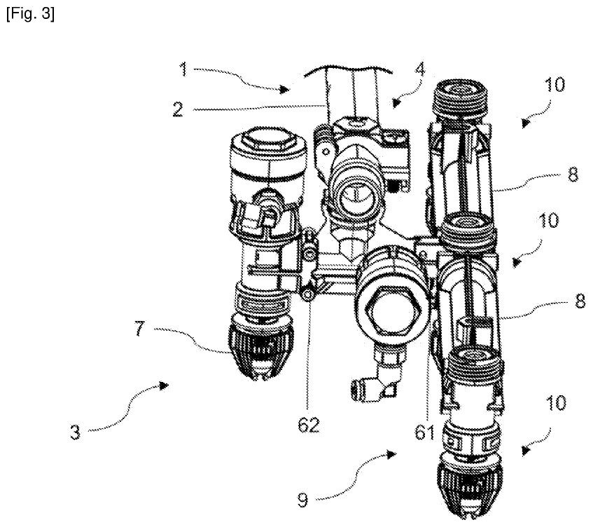

As is represented in FIG. 3, the body 4 comprises an upper part having two jaws connected and attached by means of an attachment system, here a screw-nut system, to the primary duct 2. The jaws delimit a port configured to house the primary duct 2. Thus, the nozzle holder 3 is mountable to and dismountable from the primary duct 2.

The body 4 houses a liquid intake duct 5, as represented in FIG. 1, for example for a plant protection liquid. The intake duct 5 is configured to be supplied with liquid through the primary duct 2.

In addition, the body 4 houses at least one flow regulating means.

In particular, the flow regulating means comprises at least one controllable valve. For example, the valve can extend transversely to the primary duct 2.

The intake duct 5 connects the primary duct 2 to the flow regulating means.

The nozzle holder 3 further comprises at least one first spray nozzle 7, particularly visible in FIGS. 1, 3 and 4, at least one secondary duct section 8 and at least one group of spray nozzles 9.

The secondary duct section 8 corresponds to a tube having two ends, a first end 80 and a second end 81, both being through ends.

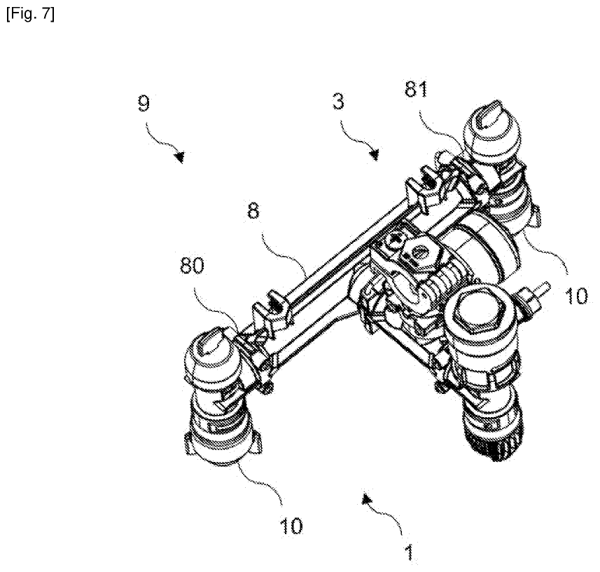

Advantageously, and as represented in FIG. 7, the group of spray nozzles 9 comprises at least two spray nozzles 10. The two spray nozzles 10 are connected to each other through the secondary duct section 8. In particular, each of the two nozzles 10 is placed at one of the ends 80, 81 of the secondary duct section 8.

The secondary duct section 8 is configured to convey liquid, for example the plant protection liquid, from the flow regulating means to each nozzle 10 of the group of spray nozzles 9.

In particular, the nozzles of the group of spray nozzles 9 are distributed over the secondary duct section 8.

According to another embodiment and as illustrated in FIGS. 1 to 3 and 5, the group of spray nozzles 9 may comprise three spray nozzles 10. In this embodiment, the nozzle holder 3 comprises two secondary duct sections 8. The three spray nozzles 10 are connected to each other through the two secondary duct sections 8. Each secondary duct section 8 thereby has a first end 80 and a second end 81.

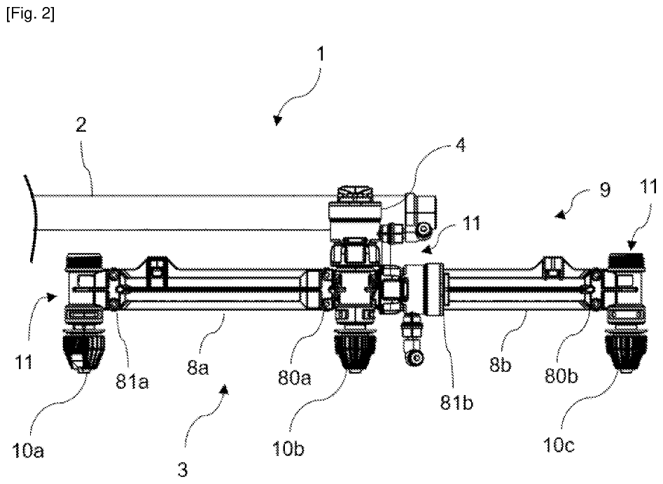

As is illustrated in FIG. 2, a first nozzle 10a of the group of nozzles 9 is connected to the second end 81a of the first secondary duct section 8a. A second nozzle 10b is connected on the one hand, to the first end 80a of the first secondary duct section 8a and on the other hand, to the second end 81b of the second secondary duct section 8b. A third nozzle 10c is connected to the first end 80b of the second secondary duct section 8b.

According to yet another embodiment illustrated in FIG. 6, the group of spray nozzles 9 comprises five spray nozzles 10 connected to each other through secondary duct sections 8, here the nozzle holder 3 comprises four secondary duct sections 8.

The group of spray nozzles 9 may comprise as many spray nozzles 9 as desired by the user.

In particular, the group of spray nozzles 9 can n comprise spray nozzles 10, the nozzle holder thereby comprises n−1 secondary duct sections 8. Said secondary duct sections 8 connect the spray nozzles 10 with each other through each of their ends.

In addition, as is represented in the figures, the spray nozzles 10 of the group of spray nozzles 9 are equidistant from each other. In particular, the secondary duct sections 8 all have the same length.

Advantageously, the spray nozzles 10 of the group of spray nozzles 9 are spaced apart by 5 to 25 cm.

According to an embodiment not represented, the spray nozzles 10 of the group of spray nozzles 9 have variable spacing between them. In particular, the secondary duct sections 8 can have different lengths, thus adapting to the specific need of each user.

The nozzles 10 of the group of spray nozzles 9 allow spraying of the liquid conveyed at intervals determined by their spacing. Their spacing therefore varies depending on the user's need. For example, the user may determine that the spacing between their nozzles 10 of the group of nozzles 9 corresponds to the spacing between rows of vegetation of their field, so as to make on-the-row spraying with the group of nozzles 9.

The group of spray nozzles 9 thus enables localized spraying.

According to a first embodiment, the flow regulating means comprises a controllable valve arranged at the interface between the intake duct 5, the first spray nozzle 7 and the secondary duct section 8.

The controllable valve comprises a liquid inlet, for example for plant protection liquid, and at least a first outlet and a second outlet. The inlet and each of the outlets are controllable.

In particular, the inlet is controllable between an open position and a closed position.

The first outlet is controllable between an open position and a closed position.

The second outlet is controllable between an open position and a closed position.

The first outlet and the second outlet are arranged downstream of the primary duct 2.

The first spray nozzle 7 is connected to the first controllable outlet of the controllable valve. The secondary duct section 8 is connected to the second controllable outlet of the controllable valve.

In the open position of the liquid inlet, the controllable valve is configured to allow supply of the first nozzle 7 and/or the group of nozzles 9 with liquid. In the closed position of the liquid inlet, the controllable valve is configured to prevent supply of the first nozzle 7 and/or the group of nozzles 9 with liquid.

In the open position of the first liquid outlet, the controllable valve is configured to allow supply of the first nozzle 7 with liquid. In the closed position of the first liquid outlet, the controllable valve is configured to prevent supply of the first nozzle 7 with liquid.

In the open position of the second liquid outlet, the controllable valve is configured to allow supply of the secondary duct section 8 with liquid. In the closed position of the second outlet, the controllable valve is configured to prevent supply of the secondary duct section 8 with liquid.

Advantageously, a plurality of controllable valves 11 are arranged at the end of the secondary duct section 8.

In particular, the number of controllable valves 11 corresponds to the number of spray nozzles 10 of the group of nozzles 9.

Each valve 11 of the plurality of valves 11 is associated with one nozzle 10 of the group of nozzles 9.

Each valve 11 is movable between a closing position and an opening position. In the closing position, the valve 11 is configured to prevent liquid from being conveyed from the second outlet of the controllable valve to the nozzle 10 with which it is associated. In the opening position, the valve 11 is configured to allow the liquid to be conveyed from the second outlet of the controllable valve to the nozzle 10 with which it is associated.

Thus, the valves 11 enable the nozzles 10 of the group of nozzles 9 to be controlled individually. The valves are independent of each other. In particular, the user or a control unit may determine the position of each of the valves 11, between its closing position and its opening position, in order to adapt the boom and the sprayed area to the user's particular needs.

Liquid, e.g. plant protection liquid, circulates in the primary duct 2. It is conveyed to the intake duct 5 of the nozzle holder 3, through which it passes, to reach the controllable valve, in particular at the inlet of the controllable valve. When the valve inlet is in the closed position, the liquid is stopped at said inlet and cannot be conveyed into the controllable valve. When the inlet of the controllable valve is in the open position, the liquid is conveyed to the first outlet and to the second outlet.

When the first outlet is in the closed position, the liquid is stopped at said outlet and cannot be conveyed to the first spray nozzle 7. When the first outlet is in the open position, the liquid is conveyed to the first spray nozzle 7, and then is sprayed through said first spray nozzle 7.

When the second outlet is in the closed position, the liquid is stopped at said outlet and cannot be conveyed to the secondary duct section 8. When the second outlet is in the open position, the liquid flows to the secondary duct section 8, to the controllable valves 11. When a valve 11 is in the closed position, the liquid is stopped by the valve and cannot be conveyed to the nozzle 10 with which the valve 11 is associated. When a valve 11 is in the opening position, the liquid is conveyed to the nozzle 10 with which the valve 11 is associated, and then is sprayed through said nozzle 10.

Opening and closing of the controllable valve and the valves 11 are independent of each other.

According to another embodiment, the flow regulating means comprises a first valve 61 and a second valve 62, different from the controllable valve of the previous embodiment. The first valve 61 is arranged at the interface between the intake duct 5 and the secondary duct section 8 and the second valve 62 is arranged at the interface between the intake duct 5 and the first spray nozzle 7.

In particular, the first valve 61 and the second valve 62 each comprise an inlet and an outlet, configured to supply the nozzles 10 of the group of nozzles 9 and the first spray nozzle 7, respectively.

Each of the inlets of the first valve 61 and the second valve 62 is controllable between an open position and a closed position.

In the open position of the inlet of the first controllable valve 61, the latter is configured to allow supply of the secondary duct section 8 with liquid. In the closed position of the first valve 61, the latter prevents supply of the secondary duct section 8 with liquid.

In this embodiment, the plurality of controllable valves 11, as described in the previous embodiment, can be arranged at the end of the secondary duct section 8. The arrangement and operation of said valves are unchanged from the previous embodiment, except that the liquid is conveyed from the first valve 61 to each of the valves 11 and not from the second outlet of the controllable valve to each of the valves 11.

In addition, the flow regulating means may comprise a shut-off valve arranged in the intake duct 5 and for supplying the first valve 61 and/or the second valve 62 with liquid or, conversely, preventing them from being supplied.

The spray boom 1 thus has at least one first spraying level with the first spray nozzle 7 and a second spraying level with the group of spray nozzles 9 distributed over the secondary duct section 8. The first level can for example be adapted to a first spraying type and the second level to a second spraying type.

For example, the first spraying type can correspond to spraying the entire field and the second spraying type can correspond to localized spraying, on a row of plants.

This means that the user can apply two different spray types on a single spray boom. In addition, the nozzles 10 of the group of nozzles 9 can be adaptably distributed over the secondary duct section 8, and thus enable spraying adapted to the user's need and/or depending on the liquid to be sprayed.

Advantageously, the first spray nozzle 7 and/or at least one spray nozzle 10 of the group of spray nozzles 9 is tilted relative to the primary duct 2.

The tilt of one or more nozzles, whether the first spray nozzle 7 and/or at least one spray nozzle 10 of the group of spray nozzles 9, makes it possible to adapt their spray spectrum. In particular, such a tilt can make it possible to tighten spray spectra of the nozzles, for example 10a, 10b, 10c (FIG. 2) so as to limit the sprayed field width, while keeping the same nozzle height.

Advantageously, the spray boom 1 comprises a plurality of nozzle holders 3 as previously described. In particular, each nozzle holder 3 is connected to the primary duct 2 of the boom 1, so that it can be supplied with liquid.

The plurality of nozzle holders 3 makes it possible to have even greater modularity of the boom 1, since each group of nozzles 9 can have a different arrangement, specific to the user's need.

The controllable valves and the valves 11 of each nozzle holder 3 are independent of each other.

According to a particular embodiment of the invention, the nozzle holders 3 of the plurality of nozzle holders 3 are equidistant from one another.

Advantageously, the nozzle holders have a standardized spacing of 25 cm, 33 cm or 50 cm.

According to another embodiment, the nozzle holders 3 of the plurality of nozzle holders 3 have variable spacing between them.

Advantageously, the first spray nozzle 7 is a nozzle configured to enable double, or even triple coverage of the sprayed surface area, and wherein the nozzles 10 of the group of spray nozzles 9 are spray nozzles with a narrower spectrum than the first spray nozzle 7.

It will also be noted that the invention is not limited to the embodiments previously described. Indeed, it will appear to those skilled in the art that various modifications may be made to the embodiments described above, in the light of the teaching that has just been disclosed thereto.

For example, the nozzles of the group of spray nozzles can be distributed over a single secondary duct section. For example, if the group of spray nozzles comprises three spray nozzles, they may be attached to one and a single section, a first nozzle may be attached to a first end of the section, a second nozzle to the second end, and a third nozzle to the center of the section. In such an embodiment, the spacing between the nozzles depends on the attachment point to the section and the length of the section may depend on the field area to be covered.

In the detailed presentation of the invention that is made previously, the terms used should not be construed as limiting the invention to the embodiments set out in the present description, but should be construed to comprise all equivalents that are within the reach of the person skilled in the art by applying their general knowledge to the implementation of the teaching that has just been disclosed to them.

1. A spray boom for an agricultural sprayer, comprising a primary duct and at least one nozzle holder connected to said primary duct and comprising:
a body housing a liquid intake duct configured to be supplied with liquid by said primary duct and housing at least one flow regulating means;
at least one first spray nozzle;
at least one secondary duct section extending in parallel to the primary duct;
at least one group of spray nozzles distributed over the secondary duct section; said at least one flow regulating means being arranged at the interface between the intake duct, the first spray nozzle and the secondary duct section and comprising a liquid inlet and at least a first controllable outlet and a second controllable outlet disposed downstream of said primary duct, the inlet and each outlet being controllable between an open position and a closed position, the first spray nozzle being connected to one of the outlets of the flow regulating means and the secondary duct section being connected to the other of the outlets of the flow regulating means, in the open position of the liquid inlet, said flow regulating means being configured to enable supply the first nozzle and/or the group of nozzles with liquid and, in the closed position of said liquid inlet, said flow regulating means being configured to prevent supply the first nozzle and/or the group of nozzles with liquid,
in the open position of the outlet connected to the first liquid nozzle, said flow regulating means being configured to enable supply of the first nozzle and, in the closed position of said liquid outlet, said flow regulating means being configured to prevent supply of the first nozzle,
in the open position of the other liquid outlet, said flow regulating means being configured to enable supply of the secondary duct section and, in the closed position of said other liquid outlet, said flow regulating means being configured to prevent supply of the secondary duct section, said spray boom being configured to spray liquid through said first spray nozzle and/or through at least one nozzle of said group of spray nozzles.

2. The spray boom according to claim 1, wherein the flow regulating means comprises two controllable valves, a first controllable valve being arranged at the interface between the intake duct and the secondary duct section and a second controllable valve being arranged at the interface between the intake duct and the first spray nozzle, the first outlet of the flow regulating means corresponding to the outlet of the first valve and the second outlet of the flow regulating means corresponding to the outlet of the second valve.

3. The spray boom according to claim 1, wherein the group of spray nozzles comprises at least two spray nozzles connected to each other through the secondary duct section, said secondary duct section being configured to convey liquid from the flow regulating means to each nozzle of said group of spray nozzles.

4. The spray boom according to claim 3, wherein a plurality of controllable valves are arranged in said secondary duct section, each valve of said plurality of valves being associated with one of the nozzles of the group of nozzles and each valve being movable between a closing position in which it is configured to prevent conveying of said liquid from the flow regulating member to the nozzle with which it is associated, and an opening position in which it is configured to allow conveying said liquid from the flow regulating member to the nozzle with which it is associated.

5. The spray boom according to claim 1, wherein the spray nozzles of the group of spray nozzles are equidistant from each other.

6. The spray boom according to claim 1, wherein the spray nozzles of the group of spray nozzles are spaced apart by 5 to 25 cm.

7. The spray boom according to claim 1, wherein the first spray nozzle and/or at least one spray nozzle of the group of spray nozzles is/are tilted relative to the primary duct.

8. The spray boom according to claim 1, comprising a plurality of nozzle holders, each nozzle holder being connected to said primary duct.

9. The spray boom according to claim 8, wherein the nozzle holders of the plurality of nozzle holders are equidistant from each other.

10. The spray boom according to claim 9, wherein the nozzle holders of the plurality of nozzle holders are spaced apart by 25 cm, or 33 cm or 50 cm.
